(19) United States
(12) Patent Application Publication
(10) Pub. No.: US 2020/0358267 A1
(43) Pub. Date: Nov. 12, 2020

(54) CREATING A CONDUIT FROM A COPPER CABLE

(71) Applicant: WESCO Distribution, Inc., Pittsburgh, PA (US)

(72) Inventor: Jerry L. ALLEN, Sarasota, FL (US)

(21) Appl. No.: 16/852,621

(22) Filed: Apr. 20, 2020

Related U.S. Application Data
(60) Provisional application No. 62/845,387, filed on May 9, 2019.

(51) Int. Cl. H02G 1/00; G02B 6/50

(52) U.S. Cl. CPC H02G 1/00; G02B 6/50

(57) ABSTRACT

A conduit is formed in a cable (10) having a plurality of wire bundles (12) by removing one or more of the centrally located bundles (12). A bundle (12) is removed by penetrating a wedge (14) into the bundle (12) and then pulling the pierced bundle (12) out of the cable (10). The bundle (12) is then engaged by wheels (18) of a device (17) and pulled out of the cable (10) thereby forming the conduit. The process is repeated dependent on the size of the cable (16) and the desired size of the conduit.

### CROSS-REFERENCE TO RELATED APPLICATION

This application claims priority of U.S. provisional application Ser. No. 62/845,387 filed on May 9, 2019 which is incorporated herein in its entirety

### TECHNICAL FIELD

This invention relates to the conversion of a copper cable into a conduit. More particularly, this invention relates to forming a conduit with a copper cable by removing some of the centrally located bundles of the cable so that a communication cable or the like can be put into the formed conduit.

### BACKGROUND

Most all modern communication systems utilize an underground conduit to carry one or more communication cables. Placing a conduit underground to receive the cables is a difficult, expensive, time-consuming and environmentally unfriendly process. A trench must be dug, which could extend for miles, and anything interfering with such digging, such as a sidewalk or the like in a city, must be removed before the trench can be dug. Then a new conduit is positioned in the trench which is then covered over, and the damage done to the environment, such as a sidewalk, will need to be replaced. Such is thus a very inefficient process.

In the meantime, there are literally miles of copper wire buried in the ground or in a conduit which at one time were used in communication or electrical systems and which have since been abandoned in favor or more modern technology. Thus, the need exists to make use of the copper cables such that the tedious process of burying a new communications conduit can be avoided.

### DISCLOSURE OF THE INVENTION

It is thus one object of one aspect of the present invention to modify and create space in existing copper cable so that it can act as a conduit for one or more communication cables.

It is an object of another aspect of the present invention wherein a pull tape or communications cable could be inserted into the conduit of the copper cable at the same time that the conduit is being formed.

These and other objects of the present invention, as well as the advantages thereof over existing prior art forms, which will become apparent from the description to follow, are accomplished by the improvements hereinafter described and claimed.

In general, a method of forming a conduit from a cable having a plurality of wire bundles includes the step of removing one or more of the wire bundles from the cable thereby creating a conduit.

In accordance with another aspect of the present invention, a method for simultaneously forming a conduit and inserting a device into the conduit includes the step of engaging one end of a wire bundle in a cable having a plurality of wire bundles. The device is attached to the other end of the engaged bundle and the bundle is removed from the cable while at the same time the device is inserted into the conduit which is formed by the removed bundle.

A method of forming a conduit from a wire according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a schematic sectional view of a conventional copper wire.

FIG. 2 is a schematic elevational view showing the manner in which a bundle of the copper cable is engaged to be pulled out of the cable.

FIG. 3 is a schematic view of a machine removing the bundle from the wire.

### PREFERRED EMBODIMENT FOR CARRYING OUT THE INVENTION

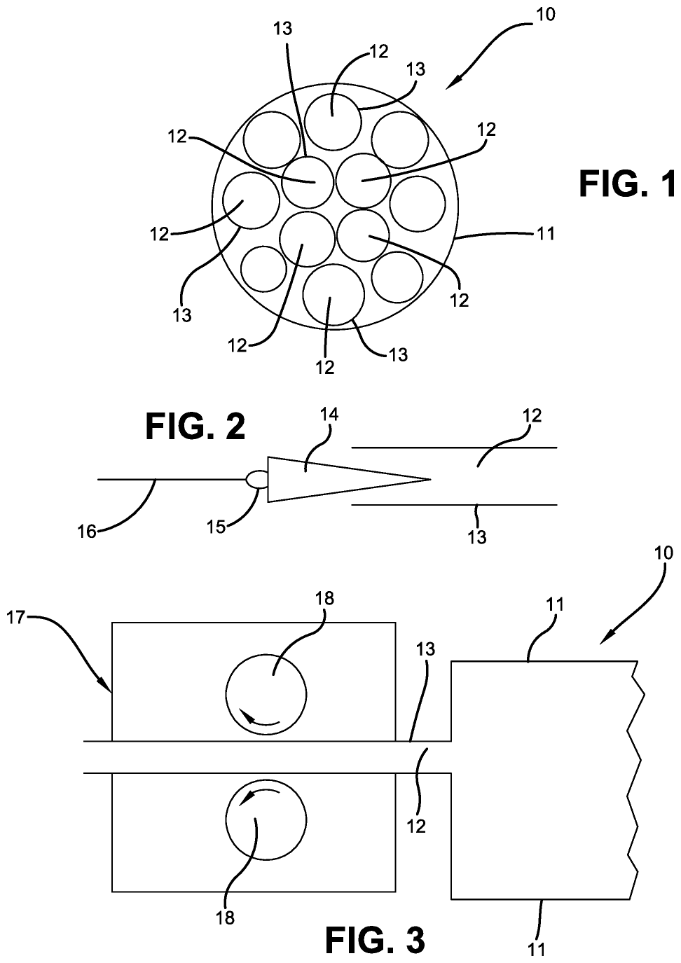

A cross-section of a conventional three hundred pair copper cable is generally indicated by the numeral 10 in FIG. 1. Cable 10 includes an outer jacket 11 which houses a plurality of wire bundles 12 in the instance twelve, twenty-five pair bundles each having a jacket 13. There are miles of such cables 10 located underground which are no longer being used to transmit signals.

In accordance with the preferred embodiment of present invention, one or more of the bundles 12, such as the central four bundles 12 within jacket 11, are removed to form a channel defined by the other eight bundles 12. To do so, as shown in FIG. 2, a wedge 14 or other device can be utilized to penetrate the end of each of the bundles to be removed. The wedge 14 may be provided with threads so as to engage the wires of the bundle as it is being inserted into the bundle. The wedge 14 can have an eyelet 15 which can be engaged by a rope or other pulling device 16 to pull a bundle 12 a short distance out of cable 10 with the threads of the wedge 14 engaging the bundle. Then, as shown in FIG. 3, a machine 17, having wheelsl8 or the like, is used to engage the exposed end of the bundles 12 and extract the bundles 12. Thus, the wheels rotate to pull the bundles 12 out of the cable 10.

Alternatively, bundles 12 may be pulled from cable 10 by a conventional take-up reel. This process is repeated a number of times (in the cable shown four times) until the desired passageway is formed.

The resulting passageway may then be used at a later date as a conduit in which one of more fiber optic communication cables may be inserted. Such is thus accomplished without disturbing or disrupting the above ground environment as would have required if a new conduit was installed in the ground.

The present invention is also advantageous in that a fiber optic or other cable could be inserted into the passageway at the same time that the passageway is being created. To that end, when one end of a bundle 12 is being engaged and pulled as shown in FIG. 3, the other end of the bundle, possibly located thousands of feet from the engaged end, can be attached to a fiber optic cable. As a result, when a bundle 12 is being removed from a cable 10, a fiber optic or other device is inserted into the conduit formed in the cable. If no cable is to be inserted at that time, a pull rope, a tape or the like can be inserted into the passageway. Such can then be used at a later date to engage and pull a fiber optic or other cable into the passageway. If the passageway is large enough to accommodate a plurality of fiber optic cables, a plurality of the bundles being removed can be attached to a fiber optic cable or pull tape in a manner described.

It should be evident that the system described herein substantially improves the art and otherwise accomplishes the objects of the invention.

What is claimed is:

1. A method of forming a conduit from a wire having a plurality of wire bundles comprising the step of removing one or more of the bundles from the cable to form the conduit.

2. The method of claim 1 wherein the step of removing includes the step of removing the generally central bundles of the cable leaving continuous outer bundles defining the conduit.

3. The method of claim 1 wherein the step of removing includes the step of engaging an end of a bundle and pulling the bundle a short distance out of the cable.

4. The method of claim 3 wherein the step of removing includes the step of engaging the exposed end of the bundle with a device, and using the device to remove the bundle from the cable.

5. The method of claim 4 further comprising the step of attaching an item to the other end of the bundle so that when the bundle is removed from the cable the item is simultaneously inserted into the conduit.

6. The method of claim 5 wherein the item is a fiber optic cable.

7. The method of claim 5 wherein the item is a pull tape.

8. A method of simultaneously forming a conduit and inserting a device into the conduit comprising the steps of engaging one end of a wire bundle of a cable having a plurality of wire bundles, attaching the device to the other end of the engaged bundle, and removing the bundle from the cable while at the same time inserting the device in the conduit formed by the removed bundle.

9. The method of claim 8 wherein the step of removing the bundle first includes the step of pulling the bundle a short distance out of the cable.

10. The method of claim 9 wherein the step of removing includes the step of engaging the exposed end of the bundle with a pulling device, and using the device to remove the bundle from the cable.

11. The method of claim 8 wherein the device is a fiber optic cable.

12. The method of claim 8 wherein the device is a pull tape.
